(19) United States
(12) Patent Application Publication
(10) Pub. No.: US 2025/0173268 A1
(43) Pub. Date: May 29, 2025

(54) OPTIMIZED SNOOP MULTI-CAST WITH MESH REGIONS

(71) Applicant: Akeana, Inc., Santa Clara, CA (US)

(72) Inventors: Madhavi Kondapaneni, Cupertino, CA (US); Aqdas Javaid, Islamabad (PK); Ayesha Zahid, Rawalpindi (PK)

(73) Assignee: Akeana, Inc., Santa Clara, CA (US)

(21) Appl. No.: 18/956,079

(22) Filed: Nov. 22, 2024

Related U.S. Application Data
(60) Provisional application No. 63/702,192, filed on Oct. 2, 2024.
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/556,944, filed on Feb. 23, 2024.
(60) Provisional application No. 63/556,951, filed on Feb. 23, 2024.
(60) Provisional application No. 63/605,620, filed on Dec. 4, 2023.
(60) Provisional application No. 63/602,514, filed on Nov. 24, 2023.
(60) Provisional application No. 63/714,529, filed on Oct. 31, 2024.
(60) Provisional application No. 63/719,841, filed on Nov. 13, 2024.

(51) Int. Cl. G06F 12/0831

(52) U.S. Cl. CPC G06F 12/0831

(57) ABSTRACT

Processor data sharing is described. A system-on-a-chip (SOC) is accessed. The SOC includes a network-on-a-chip (NOC). The NOC includes an M×N mesh topology with a coherent tile at each point of the M×N mesh topology. The M×N mesh topology is divided into a plurality of regions. Each region in the plurality of regions includes one or more coherent tiles. A snoop operation is initiated by a first coherent tile within a first region. A snoop vector is generated by the first coherent tile for each region. The snoop vector for each region selects at least one other coherent tile. The snoop operation is sent by the first coherent tile for each region. The sending is based on the snoop vector for each region. The snoop operation is processed by the at least one other coherent tile.

### RELATED APPLICATIONS

This application claims the benefit of U.S. provisional patent applications “Optimized Snoop Multi-Cast With Mesh Regions” Ser. No. 63/602,514, filed Nov. 24, 2023, “Cache Snoop Replay Management” Ser. No. 63/605,620, filed Dec. 4, 2023, “Processing Cache Evictions In A Directory Snoop Filter With ECAM” Ser. No. 63/556,944, filed Feb. 23, 2024, “System Time Clock Synchronization On An SOC With LSB Sampling” Ser. No. 63/556,951, filed Feb. 23, 2024, “Malicious Code Detection Based On Code Profiles Generated By External Agents” Ser. No. 63/563,102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, and “Vector Floating-Point Flag Update With Micro-Operations” Ser. No. 63/719,841, filed Nov. 13, 2024.

Each of the foregoing applications is hereby incorporated by reference in its entirety.

### FIELD OF ART

This application relates generally to processor data sharing and more particularly to an optimized snoop multi-cast with mesh regions.

### BACKGROUND

Fast computer processors play a crucial role in the development of new products across various industries. High-speed processors enable faster simulations and iterations in product development. This allows engineers to test multiple design variations, run simulations, and analyze results more quickly, allowing for a more rapid development cycle. In disciplines such as architecture, industrial design, animation, and gaming, fast processors allow for complex 3D modeling, rendering, and simulations. This enables the creation of detailed prototypes or visualizations that help in product design and marketing. Moreover, for products leveraging data science, machine learning, or AI, fast processors significantly speed up data processing and analysis. They help to train models more quickly and handle large datasets more efficiently, leading to quicker insights and improved product capabilities. Additionally, fast processors expedite software development by speeding up code compilation, execution, and testing. This aids developers in creating and refining software products more efficiently. For products involving graphics, high-speed processors help in creating better user interfaces, enhancing user experience, and enabling smoother interactions.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

Integrated circuits (ICs) such as processors can be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool, which in turn creates the gate-level abstraction of the design that is used for downstream implementation operations.

The development of faster computer processors significantly impacts the speed, efficiency, and capabilities of product development across various industries, leading to faster innovation, better products, and improved user experiences. In manufacturing, fast processors aid in the virtual prototyping and testing of products. This facilitates the identification of flaws or improvements in the early stages, reducing the need for physical prototypes and saving both time and resources. Moreover, faster processors can offer a level of “future-proofing” by supporting the development of products that are robust enough to meet upcoming technological advancements and user demands.

### SUMMARY

There are various types of processors, including mesh processors. Mesh processors use a mesh network to interconnect cores. In this approach, each processing core is connected to multiple neighboring cores, creating a mesh-like structure. Data travels through the shortest path to its destination, reducing latency. In particular, the mesh topology helps in reducing data transfer latency and improves overall bandwidth. With multiple pathways available for communication, data can be routed more efficiently, reducing potential bottlenecks. Additionally, mesh architectures are highly scalable. As updated designs include more cores, they can be integrated into the mesh network, allowing for efficient communication between the cores while creating processors that have more capabilities

Processor data sharing techniques are described. A system-on-a-chip (SOC) is accessed. The SOC includes a network-on-a-chip (NOC). The NOC includes an M×N mesh topology with a coherent tile at each point of the M×N mesh topology. The M×N mesh topology is divided into a plurality of regions. Each region in the plurality of regions includes one or more coherent tiles. A snoop operation is initiated by a first coherent tile within a first region. A snoop vector is generated by the first coherent tile for each region. The snoop vector for each region selects at least one other coherent tile. The snoop operation is sent by the first coherent tile for each region. The sending is based on the snoop vector for each region. The snoop operation is processed by the at least one other coherent tile.

A processor-implemented method for processor sharing data is disclosed comprising: accessing a system-on-a-chip (SOC), wherein the SOC includes a network-on-a-chip (NOC), wherein the NOC includes an M×N mesh topology, wherein the M×N mesh topology includes a coherent tile at each point of the M×N mesh topology; dividing the M×N mesh topology into a plurality of regions, wherein each region in the plurality of regions includes one or more coherent tiles; initiating, by a first coherent tile within a first region within the plurality of regions, a snoop operation; generating, by the first coherent tile, a snoop vector for each region in the plurality of regions, wherein the snoop vector for each region selects at least one other coherent tile within the M×N mesh topology; sending, by the first coherent tile, for each region in the plurality of regions, the snoop operation, wherein the sending is based on the snoop vector for each region; and processing, by the at least one other coherent tile, the snoop operation. In embodiments, the snoop vector for each region includes a region ID. In embodiments, the region ID comprises one or more bits corresponding to each region in the plurality of regions. In embodiments, the sending includes every coherent tile within each region in the plurality of regions. In embodiments, the sending is accomplished in a single clock cycle.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for optimized snoop multi-cast with mesh regions.

FIG. 2 is a flow diagram for generating a snoop vector.

FIG. 3 is a block diagram illustrating a multicore processor.

FIG. 4 is a block diagram for a pipeline.

FIG. 5 is an example 4×4 mesh with regions.

FIG. 6 is a first example of a snoop vector for a 4×4 mesh.

FIG. 7 is a first example of sending a snoop in a mesh with snoop vectors.

FIG. 8 is a second example of a snoop vector for a 4×4 mesh.

FIG. 9 is a second example of sending a snoop in a mesh with snoop vectors.

FIG. 10A is a first block diagram of a switching unit (SU).

FIG. 10B is a second block diagram of a switching unit (SU).

FIG. 11 is a system diagram for multi-cast snoop vectors within a mesh topology.

### DETAILED DESCRIPTION

Processors are ubiquitous, and are now found in everything from appliances to satellites. The processors enable the devices within which the processors are located to execute a wide variety of applications. The areas of use for these applications include power plants, space missions, data processing, patient monitoring, and vehicle access and operation control, to name a few examples. The processors are coupled to additional elements that enable the processors to execute their assigned applications. The additional elements typically include one or more of shared, common memories, communication channels, peripherals, and so on.

There are various types of processors, including mesh processors. Mesh processors use a mesh network to interconnect cores. In this approach, each processing core is connected to multiple neighboring cores, creating a mesh-like structure. Data travels through the shortest path to its destination, reducing latency. In particular, the mesh topology helps in reducing data transfer latency and improves overall bandwidth. With multiple pathways available for communication, data can be routed more efficiently, reducing potential bottlenecks. Furthermore, mesh processors can offer improved fault tolerance. If one pathway or core fails, data can often be rerouted through alternate paths, reducing the impact of a single point of failure. The improved fault tolerance can promote the stability and reliability of the processor. In critical systems such as those used in healthcare, aviation, finance, and infrastructure, maintaining operation despite faults is essential to prevent system failures that could have catastrophic consequences. In many scenarios, interruption or downtime is costly. Fault tolerance helps maintain system operations even in the face of faults, reducing downtime and ensuring continuity of service. Additionally, mesh architectures are highly scalable. As updated designs include more cores, they can be integrated into the mesh network, allowing for efficient communication between the cores while creating processors that have more capabilities.

Another factor that plays a role in the performance of computing systems is the cache hierarchy. An efficient cache hierarchy within a computer system can provide significant performance improvements. Caches are faster than main memory. An efficient cache hierarchy ensures that frequently accessed data is readily available in the fastest (closest to the processor) and smallest cache levels, reducing the time taken to access data and instructions. This enhances the overall system performance. By placing frequently used data closer to the processor, a good cache hierarchy helps in reducing memory access latency. This means that the processor spends less time waiting for data, which can otherwise cause significant delays in program execution. Moreover, caches can help reduce power consumption and improve energy efficiency by minimizing the need to access the larger, slower main memory. Accessing the cache often consumes less power than accessing the main memory, leading to overall energy savings in the system. Furthermore, by storing frequently accessed data closer to the processor, a good cache hierarchy minimizes the amount of data that needs to be fetched from the slower main memory. This reduces the memory traffic and alleviates memory bus congestion, thus enhancing overall system efficiency.

During processor execution, the contents of portions or blocks of a shared or common memory can be moved to local cache memory. The move to local cache memory can enable a significant boost to processor performance. The local cache memory is smaller, faster, and is located closer to an element that processes data than is the shared memory. The element can include a coherent tile, where a coherent tile can include a processor, cache management elements, memory, and so on. A processor can include multiple coherent tiles arranged in a mesh (grid) topology. The local cache can be shared between coherent tiles, enabling local data exchange between the coherent tiles. The local cache can enable the sharing of data between and among coherent elements, where the elements can be located within an M×N mesh topology. The use of local cache memory is beneficial computationally because cache use takes advantage of “locality” of instructions and data typically present in application code as the code is executed. Coupling the cache memory to hierarchical tiles drastically reduces memory access times because of the adjacency of the instructions and the data. A hierarchical tile does not need to send a request across a common bus, across a crossbar switch, through buffers, and so on to access the instructions and data in a shared memory such as a shared system memory. Similarly, the coherent tile does not experience the delays associated with the shared bus, buffers, crossbar switch, etc.

A cache memory can be accessed by one, some, or all of a plurality of coherent tiles within the mesh topology. The access can be accomplished without requiring access to the slower common memory, thereby reducing access time and increasing processing speed. When a memory access operation is requested by a coherent tile, the coherent tile can issue a snoop operation. The snoop operation indicates that the initiating coherent tile intends to access a portion or block of shared memory. The snoop operation is used to notify other coherent tiles within the mesh that the contents of the shared memory are to be read or written. A snoop operation associated with a write operation can include an invalidating snoop operation. Specifically, the write operation can cause a specific memory address in each processor that shares coherent memory to be invalidated. Thus, the cache lines within each processor in the system that has shared a copy of that specific memory address are no longer synchronized and must be flushed or evicted. The evicting of cache lines and filling of cache lines can be accomplished using cache management techniques.

Disclosed embodiments provide techniques for sharing data using multi-cast snoop vectors. The multi-cast snoop vectors enable notification of other coherent tiles within the mesh topology that a first coherent tile is requesting access to shared storage. The other coherent tiles that are notified include tiles which access the same address of the shared memory. The multi-cast snoop vectors support the sharing of data by enabling cache management. The cache management techniques are applied to a cache coherency block (CCB). A cache coherency block can include a plurality of processor cores, shared local caches, shared intermediate caches, a shared system memory, and so on. Each coherent tile can include a shared local cache. The shared local cache can be used to store cache lines, blocks of cache lines, etc. The cache lines and blocks of cache lines can be loaded from memory such as a shared system memory. Each of the processor cores within the CCB can manage cache lines within the local cache based on operations performed by the processor associated with the coherent tile. If data is written or stored to the shared local cache, the data becomes “dirty”. That is, the data in the local cache is different from the data in the shared memory system and other local caches. In order to maintain coherency across a cache coherency block, coherent tiles can monitor snoop operations issued by other coherent tiles within the M×N mesh topology.

A snoop operation, such as a snoop request, can be supported within the CCB. Snoop operations can manage shared local cache lines with multiple processors in a system with shared, coherent memory. The common memory can be coupled to the multiple CCBs using Network-on-Chip (NoC) technology. The snoop operations can be used to determine whether data access operations being performed by more than one coherent tile are attempting to access the same memory address in one or more caches or the shared common memory. The snoop requests can further monitor transactions such as data reads from, and data writes to, the common memory. While read operations leave data contained within a cache or the common memory unchanged, a write operation to a cache or to the common memory can change data. As a result, the copy of the data within a cache can become “incoherent” or “dirty” with respect to the common memory, either due to changes to the cache contents or changes to the common memory contents. The data changes, if not monitored and corrected using coherency management techniques, result in cache coherency problems. That is, new data can overwrite old data before the old data is used, old data can be read before new data can be written, and so on.

Techniques for sharing data using multi-cast snoop vectors within a mesh topology are disclosed. Cache coherency is crucial for maintaining consistency and correctness in a computer system. Mesh processors that include multiple processing elements (coherent tiles) that can access multiple levels of cache can further complicate the ability to maintain cache coherency. Cache coherency prevents race conditions where multiple processors try to access and modify the same data simultaneously. Without coherency protocols, data inconsistencies might occur, leading to unpredictable outcomes. While snoop operations can be used to maintain cache coherency, if the overhead of issuing snoop operations is too high, it can reduce performance gains made by using the cache hierarchy, as execution cycles spent on snoop operations can take away execution cycles that could otherwise be allocated to the computational tasks that the processor is to perform.

Disclosed embodiments mitigate the aforementioned problems by performing optimized snoop multi-cast with mesh regions. A region can include one or more coherent tiles. Thus, a region can be a subset of a mesh, and a mesh can include multiple regions. In one or more embodiments, information from a directory-based snoop filter (DSF) is utilized for the generation of snoop vectors. In one or more embodiments, the DSF is an M-way associative set of tables that can include an index number, a valid bit, a presence vector, an owner ID field, an owner valid field, a sharer field, and so on. In one or more embodiments, determining the owner can include obtaining a value in an owner ID field, and checking the validity in a corresponding owner valid field. In one or more embodiments, an invalidating snoop command signals to coherent tiles that the cache ownership may be changing. In response to receiving the invalidating snoop command, the coherent tiles write any information in the “dirty” state, and discontinue use of the cache (or locations within the cache) that are invalidated. In the context of cache memory, a dirty cache entry refers to a cache line or block that has been modified or written by a processor, but has not yet been updated in the main memory. When a processor writes to a cache line, the corresponding entry in the cache becomes “dirty” because it contains data that is different from the corresponding data in the main memory. Dirty cache entries can occur due to the write-back policies used in some cache coherence protocols. In some embodiments, the write-back policy is such that modifications made by a processor are first stored in the cache, and the updated data is only written back to the main memory when the cache line needs to be replaced or when a cache coherence operation requires it.

Based on information obtained from the DSF, snoop vectors are generated. The snoop vectors can include a coarse multi-cast snoop vector or a targeted multi-cast snoop vector. A coarse multi-cast snoop vector includes a plurality of bits, where each bit corresponds to a given region within a mesh. As an example, a mesh with four regions can be represented by a coarse multi-cast snoop vector with four bits, with each bit corresponding to a region. Alternatively, a bit encoding can be employed which uses less bits (e.g., 2 bits for 4 regions). When the bit corresponding to a given region is asserted, each coherent tile in that region receives the snoop request. Similarly, when the bit corresponding to a given region is not asserted, none of the coherent tiles in that region receive the snoop request. That is, regions that do not require the snoop vector do not receive it, conserving communication resources within the mesh by eliminating traffic and increasing bandwidth for computational communication. Moreover, when coarse multi-cast snoop vectors are used, the tiles within each region that need a snoop vector can receive it in a single clock cycle, further improving processor performance.

One or more embodiments can utilize a targeted multi-cast snoop vector. A targeted multi-cast snoop vector can include a bit field for encoding a region identifier (region ID), as well as a bit field for a coherent tile identifier (coherent tile ID) within a given region. In one or more embodiments, the targeted multi-cast snoop vector includes a bit for each coherent tile within a region. As an example, for a 4×4 mesh that includes four regions, where each region includes four coherent tiles, the targeted multi-cast snoop vector can include two bits for the region ID, and four bits for representing the coherent tiles within a given region. More generally, the targeted multi-cast snoop vector can include N bits for the region ID, where the mesh contains 2\hat{ }N regions. As mentioned above, alternative bit encodings are possible. For example, a bit can be used for each region, which results in N bits for the region ID where the mesh contains N regions. With a targeted multi-cast snoop vector, the snoop information is disseminated to the mesh over 2\hat{ }N clock cycles. That is, the snoop information is sent to one region per clock cycle. Thus, continuing with the example of a mesh with four regions, four clock cycles are used for distributing the snoop vector to the entire mesh, one region at a time. Although this may take more clock cycles than the aforementioned coarse multi-cast snoop vector, the targeted multi-cast snoop vector uses information contained in the coherent tile ID bit field to send the snoop information only to the tiles within a given region that need the snoop information. Coherent tiles that do not require the snoop information do not receive it, thereby reducing mesh traffic and enabling additional bandwidth for computational operations. Thus, disclosed embodiments enable performance for mesh-based processors that utilize a cache hierarchy. That is, disclosed embodiments combine the benefits of a mesh-based processor with the benefits of an efficient cache hierarchy.

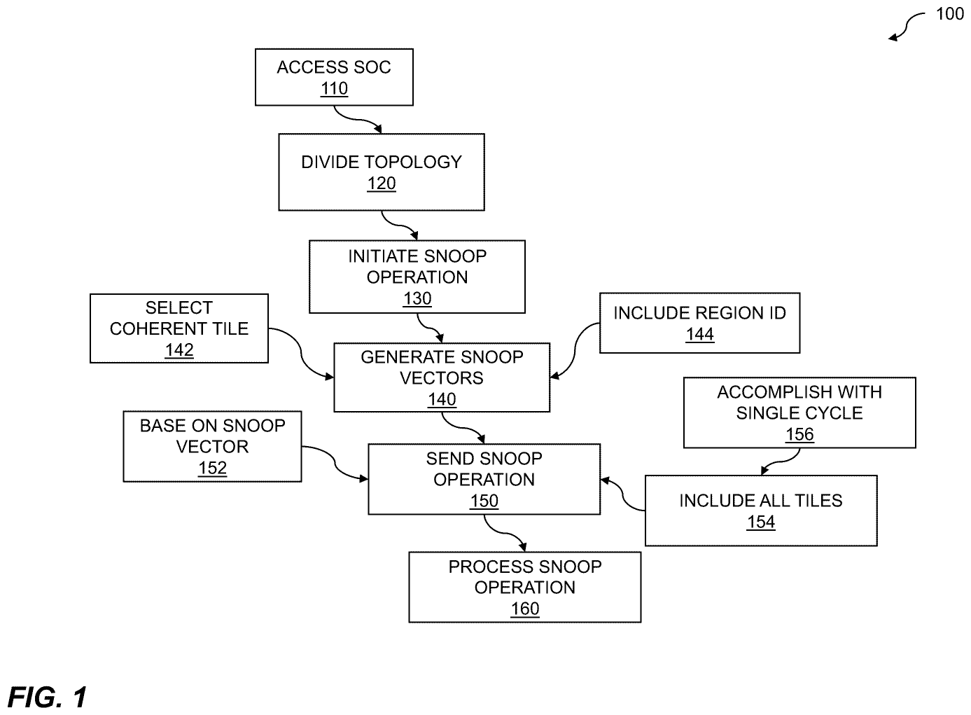

FIG. 1 is a flow diagram for optimized snoop multi-cast with mesh regions.

The flow 100 includes accessing a SoC (System-on-Chip) 110. A SoC is a semiconductor that integrates various components of a computer or electronic system into a single chip. In embodiments, the SoC can include a general-purpose SoC that is designed for a wide range of applications, such as smartphones, tablets, laptops, and other consumer electronics. General-purpose SoCs can include a mix of components like CPU, GPU, memory, wireless communication, and I/O interfaces. In some embodiments, the SoC can include an application-specific SoC. This type of SoC can be designed for specific applications or industries. For example, they might be customized for networking equipment, healthcare devices, automotive systems, or aerospace applications. In general, there are many applications for SoCs, and more continue to emerge. Such applications can include mobile devices, automotive systems, Internet of Things (IoT), consumer electronics, medical devices, and more.

A Network-on-Chip (NoC) refers to an advanced communication infrastructure used within System-on-Chip (SoC) designs. In embodiments, the SoC includes a network-on-a-chip (NoC), where the NoC includes an M×N mesh topology, wherein the M×N mesh topology includes a coherent tile at each point of the M×N mesh topology. A NoC operates on the principle of packet-switched communication, utilizing a network topology, routing protocols, and switching mechanisms to efficiently transfer data between various components on the chip. The NoC can include switching units (SUs) that manage and direct data packets from the source to the destination within the chip. Moreover, the NOC can include switches and interconnects that enable the routing of packets through the various paths available within the NoC. They facilitate communication between different components on the chip. Furthermore, the NOC can include network interfaces that connect the coherent tiles, memory, and I/O elements to the NOC, allowing them to send and receive data packets. A coherent tile can include an element in the mesh that handles coherent memory. These elements can include a processor element, a multicore processor element, an I/O interface, and so on. A switching unit is a coherent tile.

The flow 100 includes dividing the topology 120. The dividing can include dividing the M×N mesh topology into a plurality of regions, wherein each region in the plurality of regions includes one or more coherent tiles. In some embodiments, M and N are equal, such as in the case of a 4×4 mesh, 16×16 mesh, and so on. In some embodiments, M and N are not equal. Examples can include a 32×8 mesh, a 10×5 mesh, and so on. In some embodiments, all the regions within a mesh are of identical size and shape. In other embodiments, not all regions within the mesh are identical in terms of size and/or shape. As an example, for a 4×7 mesh that contains 28 coherent tiles, the topology of the mesh can be divided into 6 regions, where four of the regions include 4 coherent tiles arranged in a 2×2 shape, and two of the regions contain 6 tiles arranged in a 2×3 shape. By allowing differently sized and/or shaped regions, more flexibility can be achieved in terms of optimization. As an example, coherent tiles that receive frequent requests can be arranged accordingly in a mesh to reduce bottlenecks and enhance processer performance. When targeted multi-cast snoop vectors are used, the arrangement can include placing more active coherent tiles in a single region, or subset of the regions, and placing less frequently active coherent tiles in other regions. This approach can save clock cycles spent on cache coherency, as regions that have no coherent tiles that require snoop data can be omitted during the distribution of snoop operation data. Similarly, when coarse multi-cast snoop vectors are used, the frequently used tiles can be distributed to a subset of regions within the topology, so that traffic tends to be reduced. That is, the probability increases that the dissemination of snoop vectors is multi-cast rather than broadcast, meaning that the dissemination of snoop vectors is sent to fewer than all of the regions, thereby reducing overall traffic within the mesh topology that is implemented by the NOC.

The flow 100 continues with initiating a snoop operation 130. This can include initiating, by a first coherent tile within a first region within the plurality of regions, a snoop operation. In the context of cache coherency in multiprocessor systems, a snoop operation (also known as cache snooping) refers to the process by which a coherent tile examines or broadcasts sharing information to other processors to maintain cache coherency with other coherent tiles within the mesh topology. When multiple processors or cores in a system share access to the same memory or data, establishing cache coherency is essential. Cache coherency ensures that all caches across multiple processors have a consistent view of shared data. The snoop operation can involve monitoring each coherent tile or observing system memory operations to determine whether a particular memory location has been modified by another coherent tile in the system. This observation occurs when the coherent tile initiates a memory read or write operation. When a coherent tile issues a memory access request, it can check its cache to determine if the requested memory location is present in its cache. If the memory location is found in the cache, the coherent tile can perform a lookup to see if the cached data is still valid or if another coherent tile contains a cached version of the data that is more recent. If another coherent tile has a more recent version, the coherent tile performing the snoop operation can invalidate or update its cached copy of that data to maintain cache coherency. This ensures that all coherent tiles have consistent and updated information about shared memory, preventing data inconsistencies and ensuring correctness in a shared-memory environment. In embodiments, the snoop operation is an invalidating snoop operation.

The flow 100 continues with generating snoop vectors 140. This can include generating, by the first coherent tile, a snoop vector for each region in the plurality of regions, wherein the snoop vector for each region selects at least one other coherent tile within the M×N mesh topology. The snoop vector can be a coarse multi-cast snoop vector or a targeted multi-cast snoop vector. Within this disclosure, a targeted multi-cast snoop vector may be referred to simply as a snoop vector, and a coarse multi-cast snoop vector may be referred to as a “snoop region vector,” as the coarse multi-cast snoop vector only contains region information. In one or more embodiments, the snoop vectors (coarse or targeted) are generated based on information in a directory-based snoop filter (DSF). The DSF can identify the owners of a cache line within the system and can determine which coherent tiles require snoop data. The DSF can also identify the sharers of a cache line within the system. In one or more embodiments, the DSF is accessed by a coherent ordering agent (COA) within a coherent tile. In one or more embodiments, the COA can determine a region identifier corresponding to coherent tiles identified in the DSF, as well as process a request by a destination coherent tile and facilitate a direct cache transfer (DCT) between coherent tiles. The flow 100 can include selecting a coherent tile 142. The selected coherent tile can be another coherent tile within the M×N mesh topology. The selected coherent tile can be based on information obtained from the DSF. The flow 100 further includes including a region ID 144. The region ID corresponds to the region that contains the coherent tile that was selected.

The flow 100 continues with sending the snoop operation 150. This can include sending, by the first coherent tile, for each region in the plurality of regions, the snoop operation, where the sending is based on the snoop vector for each region. In embodiments, the sending can be accomplished among adjacent coherent tiles in a cardinal direction. Thus, a coherent tile can send data to another coherent tile in a cardinal direction. In embodiments, there can be four cardinal directions from the first coherent tile, where the four cardinal directions include a north, south, east, and west direction. The cardinal direction can be prioritized. In embodiments, the cardinal direction priority can be east/west, then north/south. Other cardinal direction priorities can be used in disclosed embodiments. The flow 100 includes basing the sending on the snoop vector 152. The snoop vector can include a targeted multi-cast snoop vector that includes region ID information and coherent tile ID information. The snoop vector can include a coarse multi-cast snoop vector (snoop region vector) that includes only region information. The region information can provide information about which regions to send a snoop operation to, and which region(s) can be omitted from the sending of a snoop operation.

The flow 100 continues with including all coherent tiles 154 within the regions specified by a snoop region vector in the sending. The flow 100 further includes accomplishing the sending to each specified region within a single cycle 156. Thus, in embodiments, the sending is accomplished with a unique clock cycle for each region in the plurality of regions. For regions that do not contain any coherent tiles that require the snoop operation, those regions can be omitted from the sending of the snoop operation. This can result in improved resource utilization within the mesh. As an example, for a 16×16 mesh topology that is divided into four regions of size/shape 4×4, each region contains 16 coherent tiles, for a total of 256 coherent tiles within the mesh topology. If ten regions out of the 16 regions contain at least one coherent tile that requires the snoop operation, then that means six regions out of the 16 regions do not need the snoop operation. In embodiments, the snoop operation is not sent to the regions that do not contain any coherent tiles that need the snoop operation. In this case, disclosed embodiments can reduce network traffic by over 37 percent. By not allocating resources for cache coherency operations, those resources are available for other operations that can contribute to the completion of computational tasks. The identification of which coherent tile(s) require the snoop operation can be based on a directory-based snoop filter (DSF) within the first coherent tile.

The flow 100 continues with processing the snoop operation 160. This can include processing, by the at least one other coherent tile, the snoop operation. The processing of the snoop operation can include processing an invalidating snoop operation. In one or more embodiments, the invalidating snoop operation signals to at least one other coherent tile that the cache ownership may be changing. In response to receiving the invalidating snoop command, the at least one other coherent tile writes any information in the “dirty” state, and discontinues use of the cache (or locations within the cache) that are invalidated.

In disclosed embodiments, cache locations (cache lines) can be in one of a variety of states, reflecting a clean or dirty status, and/or validity. One of the states can be an invalid state, indicating that the cache line is not present in a cache. Another state can include a unique clean (UC) state. In the UC state, the cache line is present only in a single cache. Another state can include a unique clean empty (UCE) state. In the UCE state, the cache line is present only in a single cache, but none of the data bytes are valid. Another state can include a unique dirty (UD) state. In the UD state, the cache line is present only in a single cache, and the cache line has been modified with respect to memory. Another state can include a unique dirty partial (UDP) state. In the UDP state, the cache line is present only in a single cache, and may include some valid data bytes. Another state can include a shared clean (SC) state. In the SC state, other caches may have a shared copy of the cache line, and the cache line might have been modified with respect to memory. Another state can include a shared dirty (SD) state. In the SD state, other caches may have a shared copy of the cache line, and the cache line has been modified with respect to memory. Disclosed embodiments can efficiently maintain cache coherency in a mesh topology by creating coarse multi-cast snoop vectors and/or targeted multi-cast snoop vectors for routing snoop operations to the regions and/or coherent tiles that require it.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

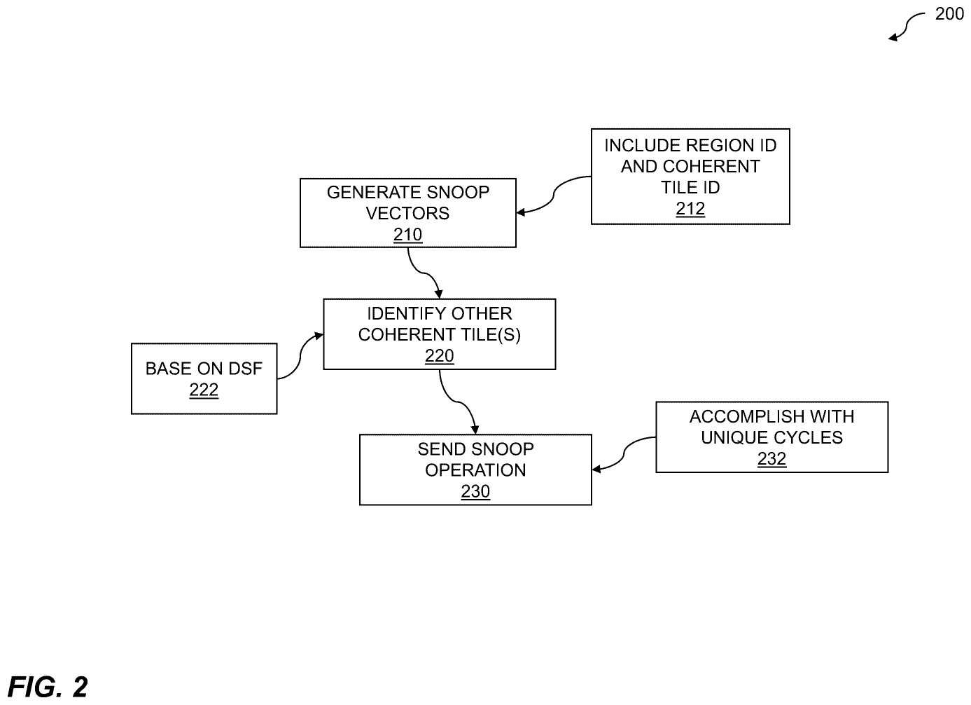

FIG. 2 is a flow diagram for generating a snoop vector. The flow 200 includes generating snoop vectors 210. The snoop vectors can include coarse multi-cast snoop vectors (snoop region vectors) and/or targeted multi-cast snoop vectors. The snoop vectors can include one or more bits. A coarse multi-cast snoop vector (snoop region vector) can include a bit for every region corresponding to a mesh topology. As an example, for a 16×16 mesh topology divided into 16 regions of 4×4 each, a 16-bit snoop region vector can be used. In alternative embodiments, the snoop region vector can utilize binary encoding, using 2\hat{ }S bits, where S is the dimension of a mesh topology. In the example with a 16×16 mesh topology, S=4, as 2\hat{ }4=16. Thus, in some embodiments, a 4-bit snoop region vector can be used instead of a 16-bit snoop region vector. The 4-bit snoop region vector requires the use of fewer bits, but may require additional time and/or circuitry for decoding the 4-bit field to identify a corresponding region.

The snoop vectors can include targeted multi-cast snoop vectors. The flow 200 can include a region ID and coherent tile ID 212. The region ID and the coherent tile ID can identify one or more other coherent tiles to which the snoop operation can be sent. A targeted multi-cast snoop vector comprises a region bit field that includes a region ID. The region ID can be a binary coded field. The targeted multi-cast snoop vector further includes a coherent tile ID bit field that indicates which coherent tile(s) within the region specified by the region bit field require the snoop operation. In embodiments, for each region, the snoop operation is only sent to the coherent tiles within the region that require the snoop operation.

The flow 200 further includes identifying at least one other coherent tile 220. In embodiments, this can include identifying, with the region ID and the coherent tile ID, the at least one other coherent tile within the M×N mesh topology. In embodiments, the identifying is based on a directory-based snoop filter (DSF) within the first coherent tile. The flow 200 can further include identifying the at least one other coherent tile based on the directory-based snoop filter (DSF) 222. In one or more embodiments, ownership of cache data is stored in an entry in the (DSF). The first coherent tile can obtain the ownership information for the cache data as part of the identifying of the other coherent tile. Thus, the first coherent tile can be a source coherent tile for the snoop operation, and the other coherent tile can be a destination coherent tile for the snoop operation.

The flow 200 further includes sending the snoop operation 230. The sending can include sending the snoop operation to one or more coherent tiles within the same region as the first coherent tile, and/or one or more coherent tiles in other regions within the mesh topology. The flow 200 can further include accomplishing the sending with unique cycles 232. Thus, in embodiments, the sending is accomplished with a unique clock cycle for each region in the plurality of regions. As an example, in a mesh topology with eight regions, it can take up to eight cycles to disseminate the snoop operation to each region. However, if one or more of the eight regions do not contain any coherent tiles that require the snoop operation, those regions can be omitted. As an example, in a mesh topology with eight regions, if only three of those regions contain coherent tiles that require the snoop operation, then the snoop operation is only sent to those three regions, saving five clock cycles. Moreover, by using the coherent tile ID within a targeted multi-cast snoop vector, only the specific coherent tile(s) within those three regions that require the snoop operation (as specified in the DSF) receive the snoop operation, further reducing the use of chip resources, particularly the packet communication resources implemented by a NOC. In embodiments, the NOC includes a point-to-point packetized communication protocol.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

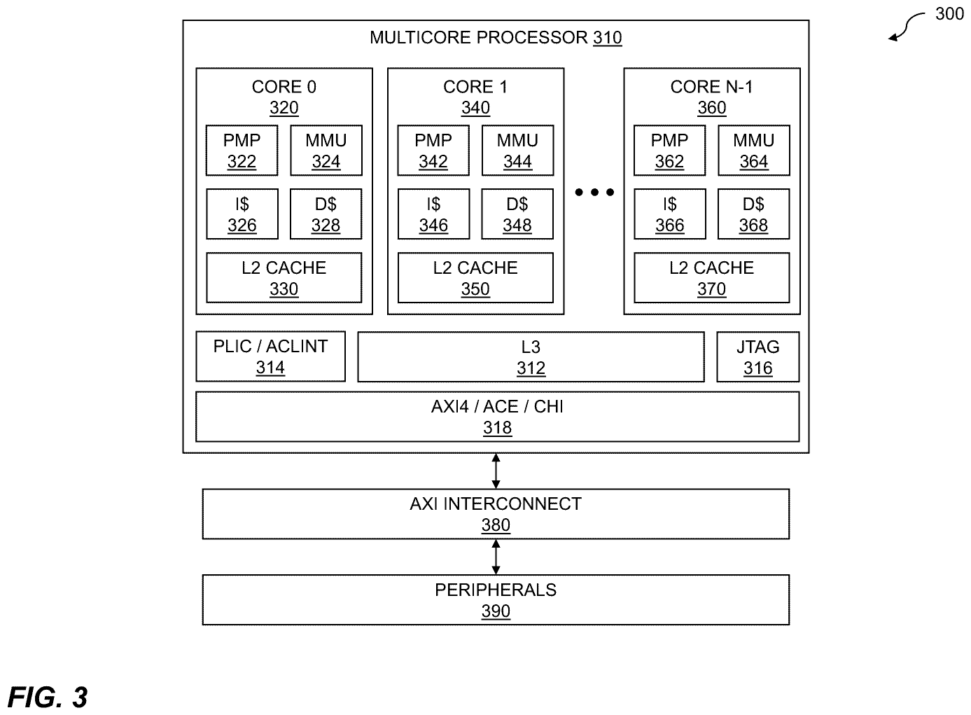

FIG. 3 is a block diagram of a multicore processor. A multicore processor can comprise two or more processor cores, where the processor cores can include homogeneous processor cores or heterogeneous processor cores. The multicore processor can be based on a RISC-V™ processor. The multicore processor can include a variety of elements. The elements can include a plurality of processor cores, one or more caches, memory protection and management units, local storage, and so on. The elements of the multicore processor can further include one or more of a private cache, a test interface such as a Joint Test Action Group (JTAG) test interface, one or more interfaces to a network such as a network-on-chip (NoC), a coupling to a common memory structure, peripherals, and the like. The multicore processor is enabled by multi-cast snoop vectors within a mesh topology.

The block diagram 300 can include a multicore processor 310. The multicore processor can comprise two or more processors, where the two or more processors can include homogeneous processors, heterogeneous processors, etc. In the block diagram, the multicore processor can include N processor cores such as core 0 320, core 1 340, core N−1 360, and so on. Each processor can comprise one or more elements. In embodiments, each core, including cores 0 through core N−1, can include a physical memory protection (PMP) element, such as PMP 322 for core 0; PMP 342 for core 1, and PMP 362 for core N−1. In a processor architecture such as the RISC-V™ architecture, a PMP can enable processor firmware to specify one or more regions of physical memory such as cache memory of the common memory, and to control permissions to access the regions of physical memory. The cores can include a memory management unit (MMU) such as MMU 324 for core 0, MMU 344 for core 1, and MMU 364 for core N−1. The memory management units can translate virtual addresses used by software running on the cores to physical memory addresses with caches, the common memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N−1. In addition to the level 1 instruction and data caches, each core can include a level 2 (L2) cache. The level 2 caches can include L2 cache 330 associated with core 0, L2 cache 350 associated with core 1, and L2 cache 370 associated with core N−1. Each core associated with multicore processor 310, such as core 0 320 and its associated cache(s), elements, and units, can be “coherency managed” by a CCB. Each CCB can communicate with other CCBs that comprise the coherency domain. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all of the cores. The further elements can be shared among the cores. The further elements can be unique to a given CCB or can be shared among various CCBs. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

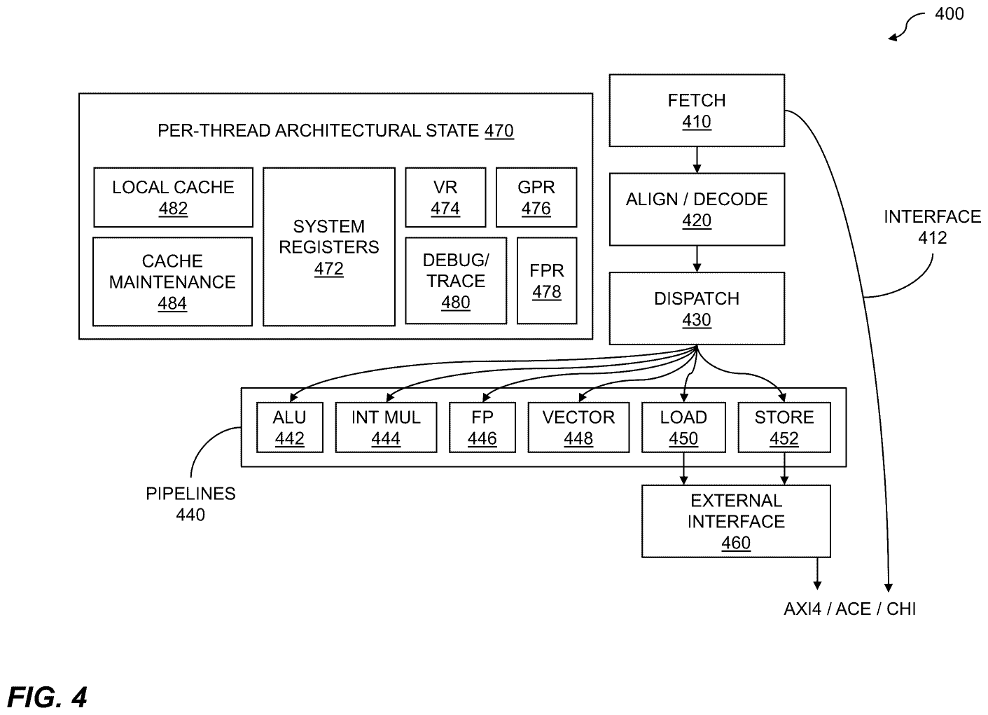

FIG. 4 is a block diagram of a pipeline. One or more pipelines associated with a processor architecture can be used to greatly enhance processing throughput. The processor architecture, such as a multicore processor architecture, can be associated with one or more processor cores, multiprocessors, storage elements, and so on. The processing throughput can be increased by executing multiple operations in parallel. The use of one or more pipelines supports multi-cast snoop vectors within a mesh topology. A system-on-a-chip (SOC) is accessed, wherein the SOC includes a network-on-a-chip (NOC), wherein the NOC includes an M×N mesh topology, wherein the M×N mesh topology includes a coherent tile at each point of the M×N mesh topology. A snoop operation is initiated by a first coherent tile within the M×N mesh topology. A snoop vector is generated by the first coherent tile, wherein the snoop vector indicates one or more other tiles within the M×N mesh topology to be notified of the snoop operation. The M×N mesh topology can be divided into multiple regions, where each region includes one or more coherent tiles. The snoop operation can be sent to a subset of regions within the M×N mesh topology. In some embodiments, the snoop operation can be sent to a subset of coherent tiles within each of the regions that receives the snoop operation.

The blocks within the block diagram 400 can be configurable in order to provide varying processing levels. The varying processing levels can be based on processing speed, bit lengths, and so on. The block diagram 400 can include a fetch block 410. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450 and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, to trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474, general purpose registers (GPR) 476, and floating-point registers 478. These registers can be used for vector operations, general purpose (e.g., integer) operations, and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 482. The architectural state can include one or more states associated with a local cache, such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

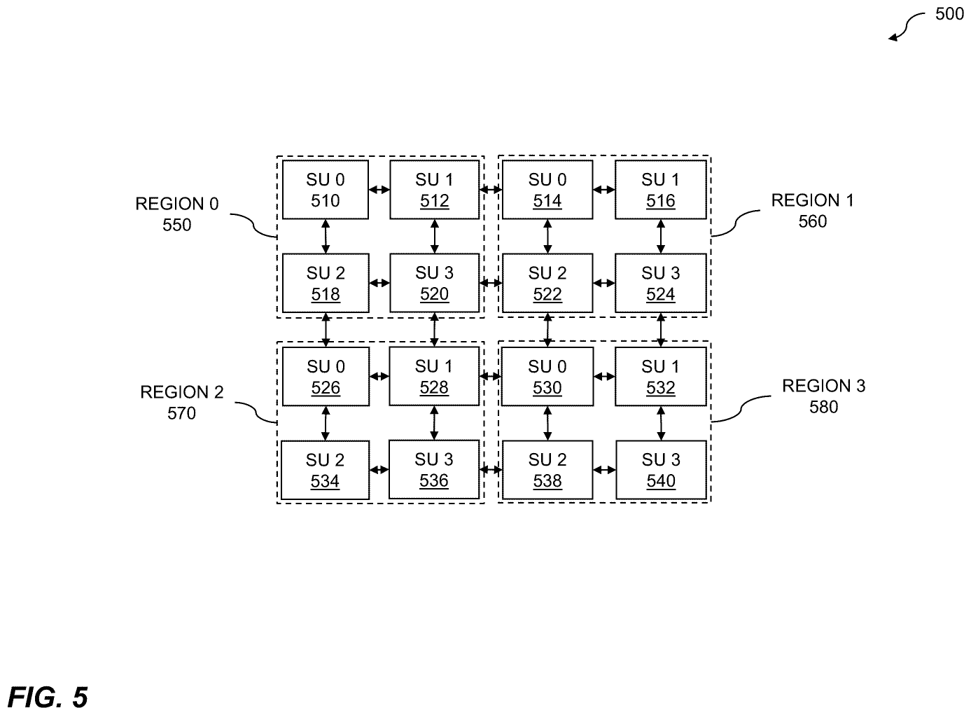

FIG. 5 is an example 4×4 mesh with regions. Discussed previously and throughout, snoop vectors such as multi-cast snoop vectors can be used to manage access to storage. The storage can include cache storage that is shared by coherent tiles associated with a system-on-a-chip (SOC). A snoop vector can be used to alert one or more other coherent tiles that a coherent tile is requesting access to an address in the shared cache storage. The access request can include a read request, a write request, a read-modify-write request, and so on. The coherent tiles can be configured within the SOC using a mesh topology. The coherent tiles can be switching units, where the switching units can include functions for routing snoop vectors to one or more tiles within the mesh topology that access the same shared storage address. The mesh topology is enabled by multi-cast snoop vectors. A system-on-a-chip (SOC) is accessed, wherein the SOC includes a network-on-a-chip (NOC), wherein the NOC includes an M×N mesh topology, wherein the M×N mesh topology includes a coherent tile at each point of the M×N mesh topology.

The coherent tiles can perform a variety of functions. In some embodiments, each coherent tile includes similar circuitry. In other embodiments, one or more coherent tiles within the M×N mesh may include different circuitry. As an example, some coherent tiles can include a CCB and a COA, whereas other coherent tiles can include input/output (I/O) control interfaces (ICIs). The SUs can include functions and/or instructions for routing snoop operations. The routing operations can be part of a packetized point-to-point communication protocol. The ICIs can support I/O operations to one or more peripherals within the SOC. Other types of coherent tiles can be included in one or more embodiments. In embodiments, the one or more other coherent tiles include one or more I/O control interfaces (ICIs).

Switching units can be configured in an M×N mesh topology. The example 500 in FIG. 5 shows an example 4×4 mesh. Multiple regions may be defined for the M×N mesh topology, where each of the multiple regions includes one or more coherent tiles. As shown in example 500, four regions are defined, indicated as region 0 550, region 1 560, region 2 570, and region 3 580. Each region is of a 2×2 configuration, where the configuration specifies a size and shape of a region. As can be seen in FIG. 5, each region comprises four coherent tiles arranged in a 2×2 square. The switching units within the mesh can include switching units SU 0 510, SU 1 512, SU 2 518, and SU 3 520, belonging to region 0 550. The switching units within the mesh can further include switching units SU 0 514, SU 1 516, SU 2 522, and SU 3 524, belonging to region 1 560. The switching units within the mesh can further include switching units SU 0 526, SU 1 528, SU 2 534, and SU 3 536, belonging to region 2 570. The switching units within the mesh can further include switching units SU 0 530, SU 1 532, SU 2 538, and SU 3 540, belonging to region 3 580.

In embodiments, a coherent tile at each point of the M×N mesh topology can be a switching unit (SU). A switching unit, which can also be referred to as a mesh switch unit, can include one or more of a cache coherency block (CCB), coherence ordering agent (COA), a memory controller interface (MCI), an input/output (I/O) mesh interface (MI), and so on. Each switching unit can include a plurality of ports. The ports can include local ports, directional ports, and the like. The ports can be used for communication with other switching units within the mesh. Each switching unit can be in communication with nearest-neighbor SUs within the matrix. The nearest neighbor SUs within the mesh topology can be in one or more cardinal directions. The cardinal directions can include north, south, east, and west. Communication with a nearest neighbor SU can be based on a cardinal direction priority. In embodiments, the cardinal direction priority can be east/west, then north/south. Noted above, the communication with nearest-neighbor SUs can be accomplished using a network-on-chip (NOC). The network-on-chip can be based on techniques including router-based packet switching.

A snoop operation is initiated by a first coherent tile within the M×N mesh topology. A snoop vector is generated by the first coherent tile, wherein the snoop vector indicates one or more other tiles within the M×N mesh topology to be notified of the snoop operation based at least in part on region information, including a region ID. One or more snoop vectors are created by the first coherent tile. The snoop vectors can include coarse multi-cast snoop vectors and/or targeted multi-cast snoop vectors, and can be based on information maintained within a directory-based snoop filter (DSF). In embodiments, the first coherent tile includes a cache coherency block (CCB) and a coherency ordering agent (COA).

The communication between switching units is based on snoop vectors. In one or more embodiments, the communicating between switching units is further based on selecting an adjacent switching unit or coherent tile. The adjacent SU is located in a cardinal direction in relation to the first SU. The cardinal direction can include north, south, east, or west. The cardinal direction priority can be used to select which cardinal direction can be chosen for communicating a snoop operation. In embodiments, the cardinal direction priority can be east/west, then north/south. While the example 500 in FIG. 5 shows four regions of equivalent configuration, embodiments can include regions of different sizes. As an example, in the case of a 4×5 region that contains 20 coherent tiles, the region allocation can include four regions, where two regions are 2×2 regions, and two regions are 2×3 regions. Some embodiments can include an odd number of regions. Again, referring to an example of a 4×5 mesh topology, the region allocation can include five regions, where each region has a 1×5 configuration. In one or more embodiments, the region definition may be implemented by the programming of one or more registers in a general register file. In one or more embodiments, the region definition may be reprogrammed based on a given computational task. Thus, in embodiments, region configurations can be changed based on execution context. In embodiments, the coherent tile at each point of the M×N mesh topology comprises a switching unit (SU).

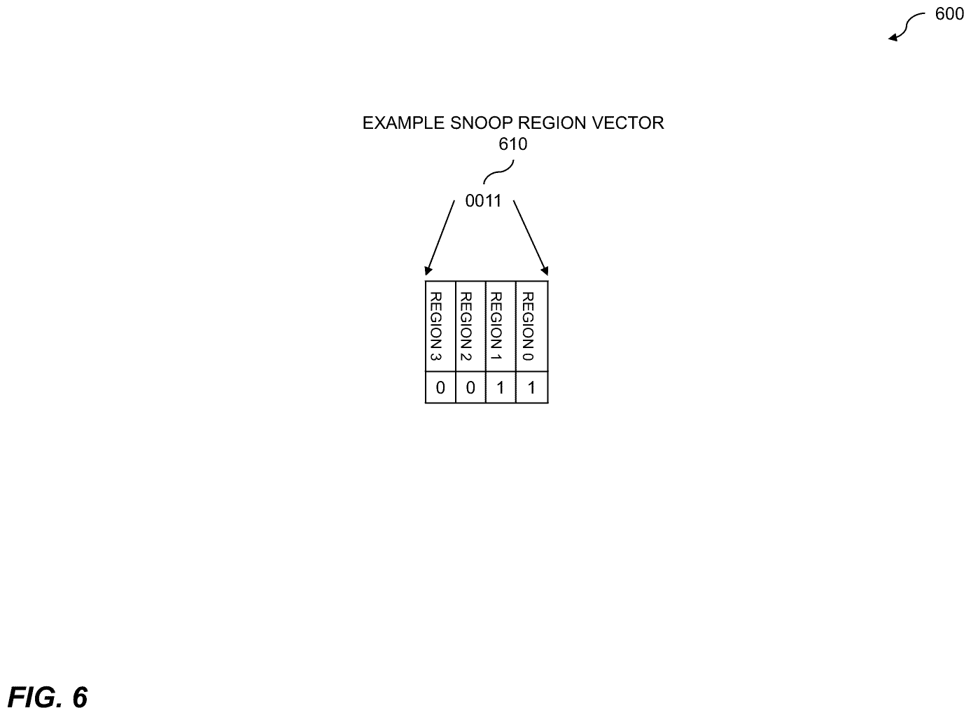

FIG. 6 is a first example of a snoop vector for a 4×4 mesh. The example 600 includes an example snoop region vector 610, also referred to as a “coarse multi-cast snoop vector.” The example 600 corresponds to a M×N mesh topology that includes four regions, such as those depicted in FIG. 5. The snoop region vector 610 includes four bits, where each bit corresponds to a given region. In the example 600, the bit corresponding to region 0 is set to 1, the bit corresponding to region 1 is set to 1, the bit corresponding to region 2 is set to 0, and the bit corresponding to region 3 is set to 0. In embodiments, a value of 1 indicates that a region contains at least one coherent tile that needs the snoop operation. Similarly, a value of 0 indicates that a region does not contain any coherent tiles that need the snoop operation. Accordingly, based on the snoop region vector in the example 600, region 0 and region 1 require the snoop operation data, and region 2 and region 3 do not require the snoop operation data. In embodiments, the snoop vector for each region includes a region ID. In embodiments, the region ID comprises one or more bits corresponding to each region in the plurality of regions.

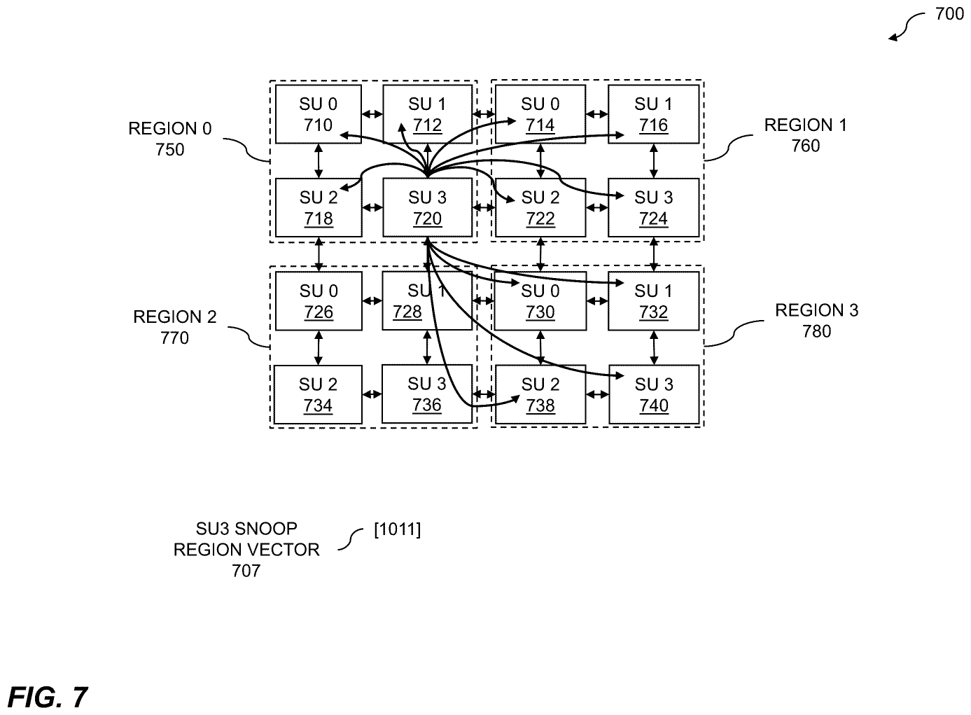

FIG. 7 is a first example of sending a snoop in a mesh with snoop vectors. The example 700 includes a 4×4 mesh topology. As shown in the example 700, four regions are defined for the mesh topology, indicated as region 0 750, region 1 760, region 2 770, and region 3 780. Each region includes a 2×2 configuration, where the configuration specifies a size and shape of a region. As can be seen in FIG. 7, each region comprises four coherent tiles arranged in a 2×2 square. The switching units within the mesh topology can include switching units SU 0 710, SU 1 712, SU 2 718, and SU 3 720, belonging to region 0 750. The switching units within the mesh topology can further include switching units SU 0 714, SU 1 716, SU 2 722, and SU 3 724, belonging to region 1 760. The switching units within the mesh topology can further include switching units SU 0 726, SU 1 728, SU 2 734, and SU 3 736, belonging to region 2 770. The switching units within the mesh topology can further include switching units SU 0 730, SU 1 732, SU 2 738, and SU 3 740, belonging to region 3 780.

In the example 700, the source coherent tile is SU 3 720, and is operating on the coarse multi-cast snoop vector indicated at 707. The coarse multi-cast snoop vector (or snoop region vector) has a binary value of 1011. In the example, the least-significant bit of the snoop region vector represents region 0 and the most-significant bit represents region 3. Thus, with the binary value of 1011, the snoop operation data is routed to region 0, region 1, and region 3, while region 2 is omitted from the dissemination of the snoop operation data. Thus, as indicated by the curved arrows originating from SU 3 720, the snoop operation data is sent from SU 3 720 to all the coherent tiles in region 0 750, region 1 760, and region 3 780. In embodiments, the sending can be accomplished in a single clock cycle. Thus, the snoop operation data is sent from SU 3 720 to SU 0 710, SU 1 712, and SU 2 718 in region 0 750. Concurrently, the snoop operation data is also sent from SU 3 720 to SU 0 714, SU 1, 716, SU 2 722, and SU 3 724 of region 1 760. Concurrently, the snoop operation data is also sent from SU 3 720 to SU 0 730, SU 1 732, SU 2 738, and SU 3 740 of region 3 780. The snoop operation data is not sent to any of the coherent tiles in region 2 770, thereby reducing traffic in the mesh topology. Thus, the coherent tiles within region 2 770 are able to perform communication operations with each other, with no impact from the sending of snoop operation data. In some embodiments, different computational tasks can be assigned to one or more regions of a mesh topology. Thus, in embodiments, a first computational task can be assigned to the coherent tiles of region 0 750, region 1 760, and region 3 780, while a second computational task can be assigned to the coherent tiles of region 2 770. With disclosed embodiments, the sending of snoop operation data corresponding to the first computational task does not impact the execution of the second computational task that is being executed in region 2 770, thereby improving overall processor performance. In embodiments, the sending includes every coherent tile within each region in the plurality of regions.

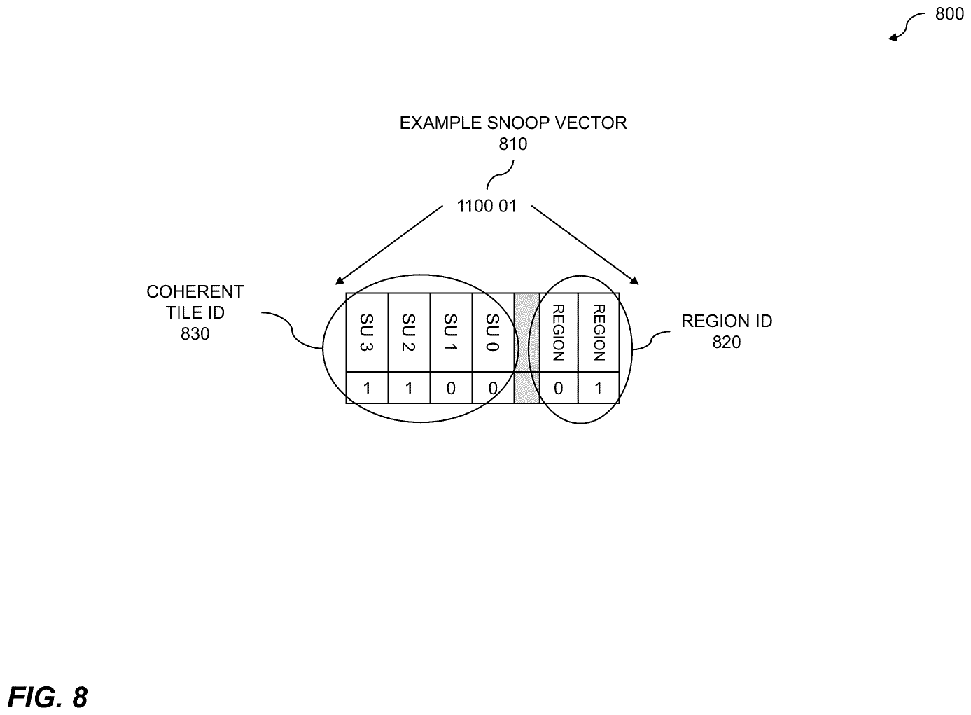

FIG. 8 is a second example of a snoop vector for a 4×4 mesh that has a total of 16 coherent tiles divided into four regions, with four coherent tiles per region. The example 800 is an example of a targeted multi-cast snoop vector 810 that includes a region identifier (ID) 820 and a coherent tile identifier (ID) 830. In embodiments, the region ID is binary coded, such that R regions can be encoded, where R=2\hat{ }X, where X is the number of bits in the region ID. In the example, there are two bits, so the number of regions that can be encoded can be described by R=2\hat{ }X=2\hat{ }2=4 regions. The coherent tile ID 830 includes a one-to-one mapping of bits to coherent tiles. Thus, the snoop vector 810 includes six bits, where the least significant two bits correspond to a binary encoded region ID, and the most significant four bits correspond to one or more of four coherent tiles within a region. Thus, the snoop vector 810 corresponds to a topology with four regions, and four coherent tiles per region, for a total of 16 coherent tiles in the topology. As shown in FIG. 8, the region ID is 01, corresponding to region 1, and the coherent tile ID field is binary 1100, corresponding to SU 3 and SU 2 of region 1. Embodiments can include identifying, with the region ID and the coherent tile ID, the at least one other coherent tile within the M×N mesh topology. In embodiments, the snoop vector for each region in the plurality of regions includes a region ID and a coherent tile ID. In embodiments, the coherent tile identifier 830 is binary encoded such that T switching units can be encoded, where T=2\hat{ }Y, where Y is the number of bits in the coherent tile ID 830.

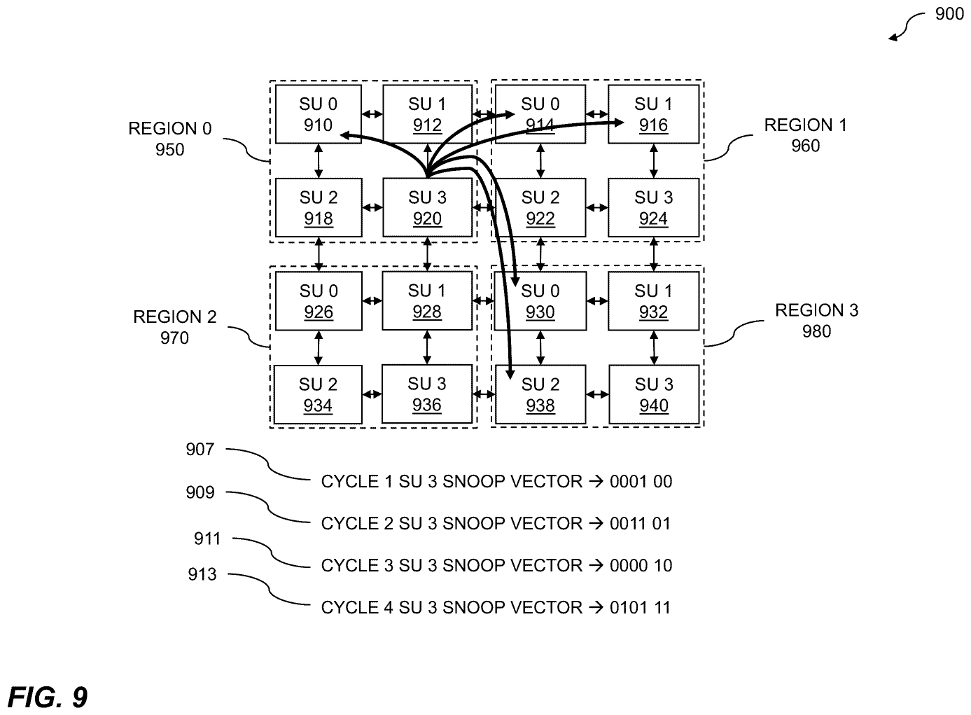

FIG. 9 is a second example of sending a snoop in a mesh with snoop vectors. Example 900 includes a 4×4 mesh topology. As shown in example 900, four regions are defined for the mesh topology, indicated as region 0 950, region 1 960, region 2 970, and region 3 980. Each region is of a 2×2 configuration, where the configuration specifies a size and shape of a region. As can be seen in FIG. 9, each region comprises four coherent tiles arranged in a 2×2 square. The switching units within the mesh topology can include switching units SU 0 910, SU 1 912, SU 2 918, and SU 3 920, belonging to region 0 950. The switching units within the mesh topology can further include switching units SU 0 914, SU 1 916, SU 2 922, and SU 3 924, belonging to region 1 960. The switching units within the mesh topology can further include switching units SU 0 926, SU 1 928, SU 2 934, and SU 3 936, belonging to region 2 970. The switching units within the mesh topology can further include switching units SU 0 930, SU 1 932, SU 2 938, and SU 3 940, belonging to region 3 980.

In the example 900, the source coherent tile is SU 920, and is operating on the set of targeted multi-cast snoop vectors indicated at 907, 909, 911, and 913. The snoop operation data is sent out over the course of multiple unique clock cycles. However, unlike the coarse multi-cast snoop vector (snoop region vector), with the targeted multi-cast snoop vectors, the snoop operation data is sent only to the specific coherent tiles that require the snoop operation data. Referring now to targeted multi-cast snoop vector 907, it has a value of 0001 00, which indicates region 0 950, and the coherent tile SU 0 910 as the recipient of the snoop operation data. Referring now to targeted multi-cast snoop vector 909, it has a value of 0011 01, which indicates region 1 960, and the coherent tile SU 0 914 and SU 1 916 as the recipients of the snoop operation data. Referring now to targeted multi-cast snoop vector 911, it has a value of 0000 10, which indicates region 2 970. However, as the coherent tile field is all zeros, it indicates that none of the coherent tiles (SU 0 926, SU 1 928, SU 2 934, and SU 3 936) in region 2 970 need the snoop operation data. Hence, no operational data is sent to region 2 970. Referring now to targeted multi-cast snoop vector 913, it has a value of 0101 11, which indicates region 3 980, and the coherent tile SU 0 930 and SU 2 938 as the recipients of the snoop operation data. In some embodiments, four cycles are required to send snoop operation data to four regions. In some embodiments, if a region has no coherent tiles that require the snoop operation data (e.g., region 2 970), then that region can be skipped, and the snoop operation data can be sent to the M×N mesh topology in a reduced number of cycles. In the example 900, the snoop operation data can be sent in three cycles, with sending to region 0 950 on the first cycle, sending to region 1 960 on the second cycle, and sending to region 3 980 on the third cycle, skipping region 2 970 since it has no coherent tiles set in targeted multi-cast snoop vector 911. In this way, disclosed embodiments can efficiently disseminate snoop operation data to coherent tiles that need it, while not sending the snoop operation data to any coherent tiles that do not require that data, thereby improving overall processor performance. In embodiments, the sending is based on a region priority. As shown in the example 900, the snoop operation data is sent to region 0 950 first, followed by region 1 960, and so on. Embodiments can use a different priority than shown in example 900. For instance, the priority can be in reverse, with region 3 having the highest priority and region 0 having the lowest priority. Other priority schemes are possible in disclosed embodiments.

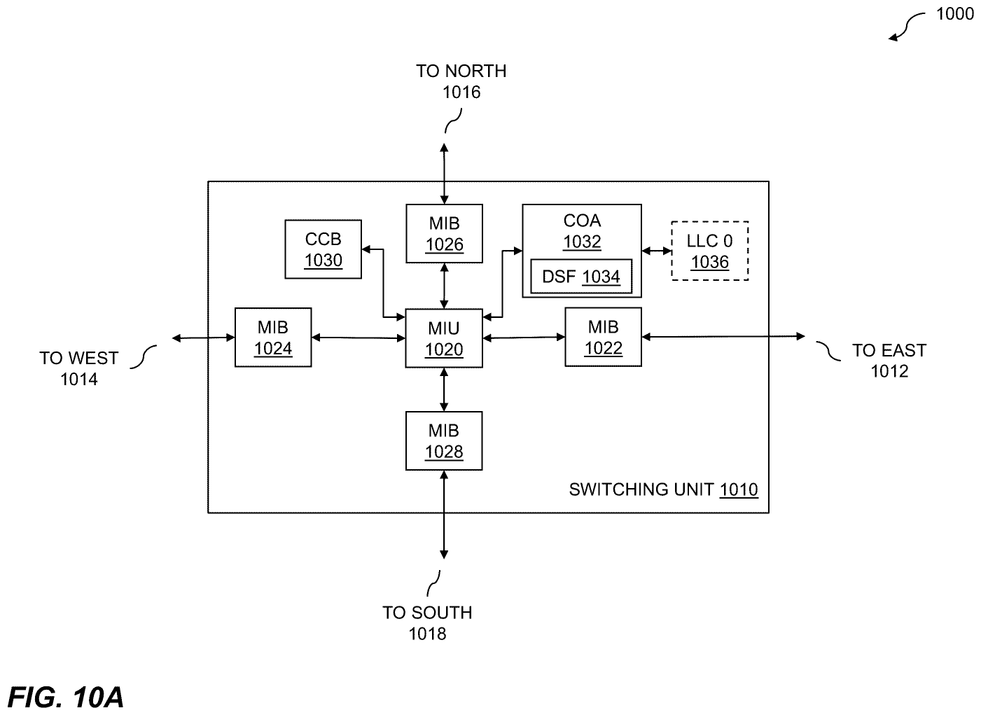

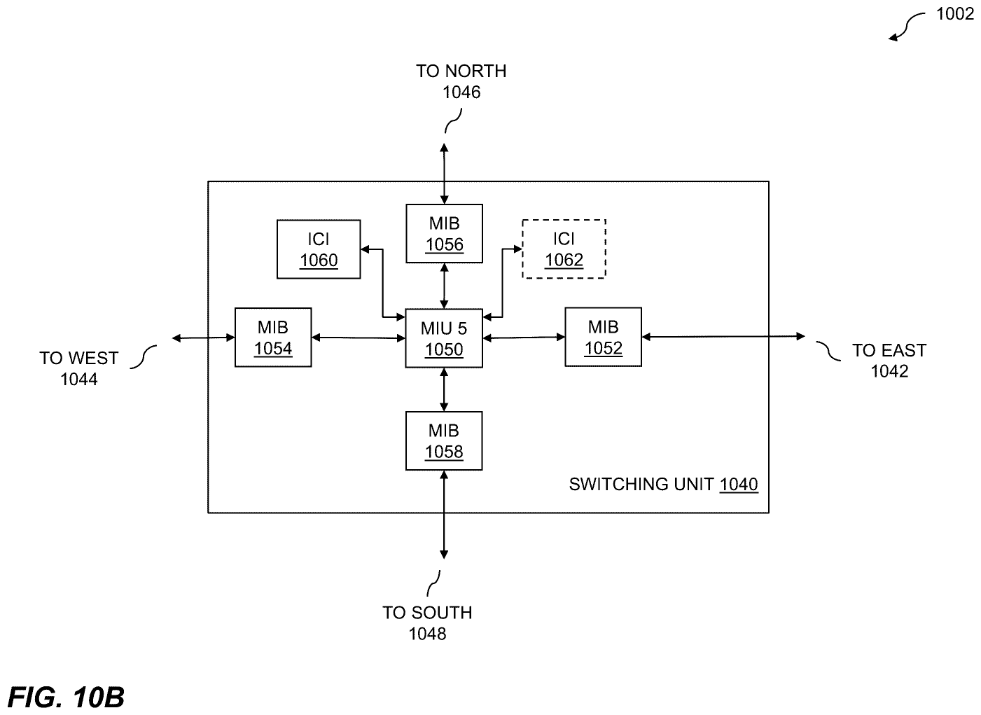

FIG. 10A is a first block diagram of a switching unit (SU). Discussed previously and throughout, a plurality of switching units can be configured in an M×N topology. The switching units can include one or more of a memory controller interface, an I/O mesh interface, and so on. A SU or tile can further include elements for managing coherency across the M×N topology. The various elements of a switching unit support multi-cast snoop vectors within a mesh topology. A system-on-a-chip (SOC) is accessed, wherein the SOC includes a network-on-a-chip (NOC), wherein the NOC includes an M×N mesh topology, wherein the M×N mesh topology includes a coherent tile at each point of the M×N mesh topology. A snoop operation is initiated by a first coherent tile within the M×N mesh topology. A snoop vector is generated by the first coherent tile, wherein the snoop vector indicates one or more other tiles within the M×N mesh topology to be notified of the snoop operation. One or more targeted multi-cast snoop vectors and/or coarse multi-cast snoop vectors are created by the first coherent tile based on information in a DSF and are used for sending snoop operation data to one or more other coherent tiles.

A mesh topology can include M×N elements in a mesh, grid, fabric, or other suitable topology. The M×N elements, which can be referred to generically as tiles associated with the mesh topology, can include elements based on a variety of configurations that perform a variety of operations, and so on. The tiles have been described as switching units (SUs), where the switching units can communicate with their nearest neighbor SUs that are located in cardinal directions from each SU. A given SU can be configured to perform one or more operations. Each SU can include one or more elements. An SU can be configured as a coherent mesh unit (CMU), a memory controller interface (MCI), an I/O control interface (ICI), and so on. A first block diagram 1000 of a switching unit is shown. The SU can be configured to enable coherency management. The switching unit (SU) 1010 can communicate with nearest neighbor SUs that are located in cardinal directions from the SU. The nearest neighbor communications can include cardinal directions to the east 1012, to the west 1014, to the north 1016, and to the south 1018. Recall that the cardinal directions can be prioritized. In embodiments, the cardinal direction priority can be east/west, then north/south.

The switching unit 1010 can include a mesh interface unit (MIU) 1020. In embodiments, the MIU can initiate a snoop operation. The snoop operation can be associated with a memory access operation such as a read (load), write (store), read-modify-write, and so on. In embodiments, the switching unit can generate a snoop vector. The snoop vector can be based on information in the DSF 1034 which can keep track of all the owners and sharers of cache lines within an address range in the system. The snoop vector can include one or more other tiles within the M×N mesh topology to be notified of the snoop operation. The one or more other tiles within the mesh topology can access a substantially similar address in storage such as a shared storage element or system. The shared storage can include shared cache storage. The MIU can communicate with other MIUs associated with further switching units using one or more interfaces. The switching unit 1010 can include one or more mesh interface blocks (MIBs). The MIBs can enable communication between the SU and other SUs within the mesh. The other SUs can be located in cardinal directions from the SU. The SU shown can include four MIBs such as MIB 1022, MIB 1024, MIB 1026, and MIB 1028. MIB 1022 enables communication to the east, MIB 1024 enables communication to the west, MIB 1026 enables communication to the north, and MIB 1028 enables communication to the south.

In embodiments, the switching unit comprises a coherent tile. The coherent tile can accomplish coherency within a block such as a cache coherency block. The cache coherency block can include processors such as processor cores, local cache memory, shared cache memory, intermediate memories, and so on. In embodiments, the first coherent tile includes a cache coherency block (CCB) such as CCB 1030 and a coherency ordering agent (COA) such as COA 1032. The CCB can include a “block” of storage, where the block can include one or more of shared local cache, shared intermediate cache, and so on. The CCB can maintain coherency among cores such as processor cores, tiles, switching units, etc. The COA can be used to control coherency with other elements outside of the M×N mesh. The CCB and the COA can be included in one or more coherent tiles of switching units within the M×N mesh. In embodiments, the adjacent coherent tile can include a CCB and a COA. The adjacent block CCB and COA can be used to maintain memory coherency within the adjacent coherent tile. In embodiments, the adjacent coherent tile can include one or more memory control interfaces (MCIs).

The COA can be used to order cache accesses based on an address to be accessed. The address can include a target address associated with a memory load operation or a memory store operation. The COA can include a directory-based snoop filter (DSF) such as DSF 1034. The DSF can be used to determine the current owner of a block of memory within the system. The DSF 1034 can also determine the sharers of a block of memory within the system. The DSF can store information pertaining to a specific address range. The block of memory can include a cache line, a block of cache lines, and so on. In embodiments, the DSF can include an M-way associative set of tables that includes an index number, a valid bit, a presence vector, an owner ID field, an owner valid field, and so on. The COA can be used to determine which cache to access. The cache can include a last level cache such as last level cache (LLC) 0 1036. The LLC can be accessible by two or more of the switching units within the M×N mesh, a plurality of M×N meshes, and so on. The LLC can include a cache between the M×N mesh and a shared memory such as a shared system memory. In embodiments, the DSF determines the current owner of a cache line. In embodiments, the DSF determines one or more sharers of a cache line. In embodiments, the DSF stores information pertaining to a specific address range.

The cache coherency, as described above and throughout, can be based on snoop requests and snoop responses. The snoop requests and the snoop responses can be communicated among the tiles of the M×N mesh using various communication techniques appropriate to accessing a system-on-a-chip (SOC). The communication techniques can be based on one or more subnetworks associated with the M×N mesh. In embodiments, the subnetworks can include a request subnetwork (REQ). The REQ can receive requests for memory access from one or more cache coherency blocks (CCBs) and can send the requests to one or more coherency ordering agents (COAs). The REQ can further receive requests from one or more COAs and can send the requests to one or more memory I/O devices. The memory I/O devices can be associated with memories such as shared local, intermediate, and last level caches; a shared memory system; and the like. In embodiments, the subnetworks can include a snoop subnetwork (SNP). The snoop subnetwork can be used to send snoop requests to cache control blocks associated with one or more tiles within the M×N mesh.

In embodiments, the subnetworks can include a completion response network (CRSP). A completion response can be associated with completion of a memory access operation. The completion response can be received from a memory such as a shared cache memory, shared system memory, and so on. The completion response can be sent to one or more cache ordering agents associated with one or more tiles within the M×N mesh. In embodiments, the subnetworks can include a snoop response subnetwork. A snoop response can include a response to a snoop initiated by a coherent tile (e.g., a switching unit) within the M×N array. A snoop response can include a snoop response status. A snoop response received from a memory can be sent to one or more coherency ordering agents. The snoop response subnetwork can also receive a completion acknowledgment from one or more cache coherency blocks. The completion acknowledgment, such as a CompletionAck, can be sent to one or more coherency ordering agents.

FIG. 10B is a second block diagram of a switching unit (SU). The previous block diagram showed a switching unit block diagram where the SU included elements for managing cache coherency. A second block diagram of a switching unit or tile can show an SU configuration that includes one or more input/output (I/O) control interfaces (ICIs). The one or more ICIs support multi-cast snoop vectors within a mesh topology. The second block diagram can include one or more elements, where the one or more elements can include substantially similar elements found in the first block diagram, substantially different elements, and so on. Discussed above and throughout, the mesh topology includes M×N elements. The M×N elements or tiles within the mesh topology can be included based on SU configurations, operations performed, and so on. The tiles, also described as switching units, can communicate with their nearest neighbor SUs that are located in cardinal directions from each SU. A given SU can be configured to perform one or more operations. Each SU can include one or more elements. A second block diagram 1002 of a switching unit is shown. The switching unit 1040 or tile can communicate with nearest neighbor SUs that are located in cardinal directions from the SU 1040. The nearest neighbor communications can include cardinal directions to the east 1042, to the west 1044, to the north 1046, and to the south 1048. The cardinal directions can be prioritized, such as in embodiments, the cardinal direction priority can be east/west, then north/south.

The switching unit 1040 can include a mesh interface unit (MIU) 1050. In embodiments, the MIU can initiate a snoop operation. The snoop operation can be associated with I/O control operation. The I/O control interface can enable communication from the switching unit to other switching units using a network-on-chip (NoC) technique. Communications between an SU and one or more other SUs can include one or more snoop requests, one or more snoop responses, etc. The snoop requests and responses can be associated with memory accesses such as load accesses, store accesses, and so on. The MIU can communicate with other MIUs associated with further switching units using one or more interfaces. The switching unit 1040 can include one or more mesh interface blocks (MIBs). The MIBs can enable communication between the SU 1040 and other SUs within the mesh. The other SUs can be located in cardinal directions from the SU 1040. The SU shown can include four MIBs such as MIB 1052, MIB 1054, MIB 1056, and MIB 1058. MIB 1052 enables communication to the east, MIB 1054 enables communication to the west, MIB 1056 enables communication to the north, and MIB 1058 enables communication to the south. In embodiments, the adjacent coherent tile can include one or more I/O control interfaces (ICIs). The switching unit 1040 can communicate with other tiles within the M×N mesh using one or more I/O control interfaces. The switching unit can include an I/O control interface 1060. The I/O control interface can control access by the MIU to send snoop requests, to receive snoop responses, and so on. More than one I/O control interface can be included. In the switching unit 1040, an additional ICI such as ICI 1062 can be included.

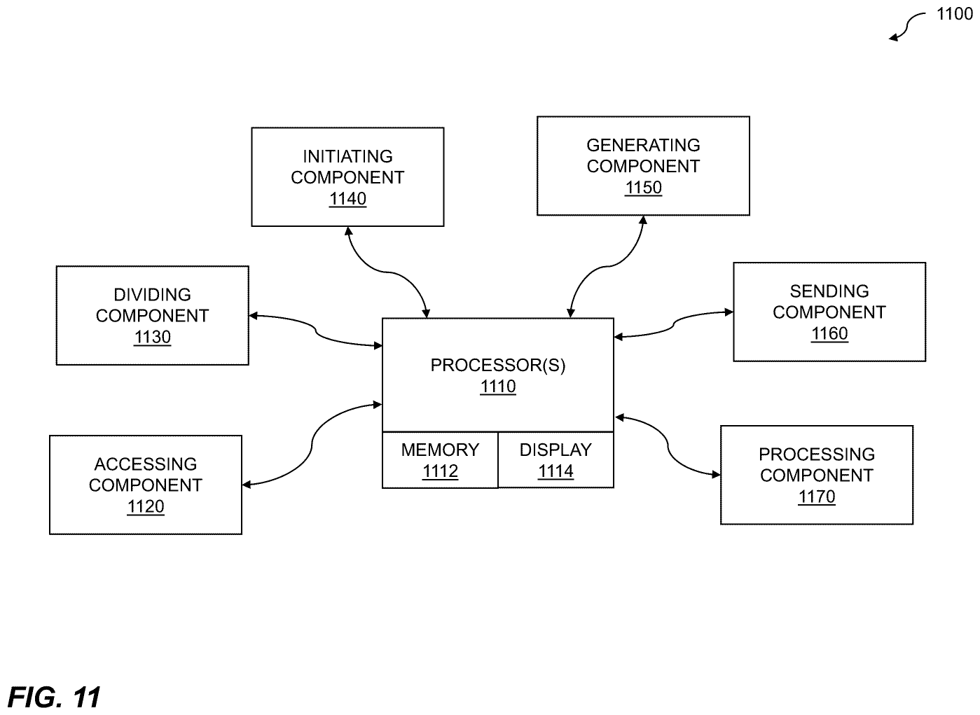

FIG. 11 is a system diagram for multi-cast snoop vectors within a mesh topology. The system can comprise a processor-implemented system for sharing data. The computer system can be based on semiconductor logic. The system can include one or more of processors, memories, cache memories, queues, displays, and so on. The system 1100 can include one or more processors 1110. The processors can include standalone processors within integrated circuits or chips, processor cores in FPGAs or ASICs, two or more processor cores within a multiprocessor, and so on. The one or more processors 1110 are coupled to a memory 1112, which stores instructions, operations, snoop vectors, local snoop vectors, directional snoop vectors, and so on. The memory can include one or more of local memory, shared cache memory, shared hierarchical cache memory, system memory such as shared system memory, etc. The system 1100 can further include a display 1114 coupled to the one or more processors 1110. The display 1114 can be used for displaying data, instructions, operations, memory queue contents, various types of vectors, and the like. The operations can include snoop operations and snoop operation responses. The operations can further include cache maintenance operations, Advanced extensible Interface (AXI™) Coherence Extensions (ACE™) cache transactions, Advanced Microcontroller Bus Architecture (AMBA™) Coherence Hub Interface (CHI™) transactions, etc.

The system 1100 can include an accessing component 1120. The accessing component 1120 can include functions and instructions to enable accessing a system-on-a-chip (SOC). A SOC can include a variety of elements associated with a computing system such as one or more processor cores, input/output interfaces, local memory, memory interfaces, secondary memory interfaces, and so on. The SOC can further include elements such as radio frequency (RF) components, graphics processors, network-on-a-chip (NOC) connectivity, etc. The SOC can be based on one or more chips, FPGAs, ASICs, etc. In embodiments, the processor cores associated with the SOC can include RISC-V™ processor cores. Memory such as local memory within the SoCs includes a local cache. The local cache can include a shared local cache. The shared local cache that can be colocated with other elements associated with the SOC, can be accessible by a processor core within the SOC, and so on. The processor cores can implement special cache coherency operations. The cache coherency operations can include maintenance operations such as cache maintenance operations (CMOs). The cache coherency operations can include a cache line zeroing operation, a cache line cleaning operation, a cache line flushing operation, a cache line invalidating operation, and so on.

A plurality of processor cores and coupled local caches within an SOC can include a coherency domain. The coherency can include coherency between the common memory and cache memory, such as level 1 (L1) cache memory. L1 cache memory can include a local cache coupled to groupings of two or more processor cores. The coherency between the common memory and one or more local cache memories can be accomplished using cache maintenance operations (CMOs), described previously. In embodiments, two or more processor cores can generate read operations for a common memory structure. The read operations for the common memory can occur based on cache misses to local cache, thereby requiring the read operations to be generated for the common memory. In embodiments, each processor core within the SOC can access a common memory structure. The access to the common memory structure can be accomplished through a coherent network-on-chip. The common memory can include on-chip memory, off-chip memory, etc. The coherent network-on-chip comprises a global coherency.

The system 1100 can include a dividing component 1130. The dividing component 1130 can include functions and instructions for dividing an M×N mesh topology into multiple regions. The dividing component 1130 can divide an M×N mesh topology into regions of equal size and shape, or alternatively can divide an M×N mesh topology into regions that vary in size and/or shape. In embodiments, the dividing component 1130 can divide the M×N mesh topology into multiple regions based on computational tasks, operational requirements, performance requirements, and/or other criteria.

The system 1100 can include an initiating component 1140. The initiating component can include functions and instructions for initiating, by a first coherent tile within a first region within the plurality of regions, a snoop operation. The snoop operation can include an invalidating snoop operation, a forwarding snoop operation, and/or other snoop operations. The system 1100 can include a generating component 1150. The generating component 1150 can include functions and instructions for generating, by the first coherent tile, a snoop vector for each region in the plurality of regions, wherein the snoop vector for each region selects at least one other coherent tile within the M×N mesh topology. The snoop vector can include a targeted multi-cast snoop vector that includes a region ID field and a coherent tile ID bit field. The snoop vector can include a coarse multi-cast snoop vector (snoop region vector), that only includes a region ID field and does not include a coherent tile ID bit field. The size of the snoop vector can be dependent on the number of regions and/or number of coherent tiles per region in a mesh topology.

The system 1100 can include a sending component 1160. The sending component 1160 can include functions and instructions for sending, by the first coherent tile, for each region in the plurality of regions, the snoop operation, wherein the sending is based on the snoop vector for each region. The sending component 1160 can send the snoop operation to multiple regions in a single clock cycle using a coarse multi-cast snoop vector. In embodiments, the sending is accomplished in a single clock cycle. The sending component 1160 can send the snoop operation to multiple regions by sending the snoop operation to each region of the multiple regions in a unique clock cycle using a targeted multi-cast snoop vector. With a targeted multi-cast snoop vector, the snoop data is only sent to the coherent tiles within the region that needs the snoop operation data, as per the coherent tile ID bit filed of the targeted multi-cast snoop vector (e.g., 830 of FIG. 8).

The system 1100 can include a processing component 1170. The processing component 1170 can include functions and instructions for processing, by the at least one other coherent tile, the snoop operation. The processing can include writing cache data to main memory, invalidating cache data, transferring cache data, and/or other cache coherency operations. For example, if one coherent tile modifies a memory location, it must inform other coherent tiles that they must invalidate their copies of the same memory location. Invalidation operations ensure that outdated data is not used, and other caches are updated accordingly. Some cache coherency protocols use an update or write-back operation, allowing a coherent tile that modified data in its cache to update the main memory or other caches. This operation ensures that the modified data is reflected in other caches, maintaining coherency across the system. In one or more embodiments, a cache coherency protocol such as MESI (Modified, Exclusive, Shared, Invalid), MOESI (Modified, Owner, Exclusive, Shared, Invalid), or MSI (Modified, Shared, Invalid), is used in order to define and regulate cache coherency operations to ensure data consistency and integrity across multiple caches in a mesh topology system

The system 1100 can include a computer program product embodied in a non-transitory computer readable medium for processor data sharing, the computer program product comprising code which causes one or more processors to generate semiconductor logic for: accessing a system-on-a-chip (SOC), wherein the SOC includes a network-on-a-chip (NOC), wherein the NOC includes an M×N mesh topology, wherein the M×N mesh topology includes a coherent tile at each point of the M×N mesh topology; dividing the M×N mesh topology into a plurality of regions, wherein each region in the plurality of regions includes one or more coherent tiles; initiating, by a first coherent tile within a first region within the plurality of regions, a snoop operation; generating, by the first coherent tile, a snoop vector for each region in the plurality of regions, wherein the snoop vector for each region selects at least one other coherent tile within the M×N mesh topology; sending, by the first coherent tile, for each region in the plurality of regions, the snoop operation, wherein the sending is based on the snoop vector for each region; and processing, by the at least one other coherent tile, the snoop operation.

The system 1100 can include a computer system for processor data sharing comprising: a memory which stores instructions; one or more processors coupled to the memory wherein the one or more processors, when executing the instructions which are stored, are configured to: access a system-on-a-chip (SOC), wherein the SOC includes a network-on-a-chip (NOC), wherein the NOC includes an M×N mesh topology, wherein the M×N mesh topology includes a coherent tile at each point of the M×N mesh topology; divide the M×N mesh topology into a plurality of regions, wherein each region in the plurality of regions includes one or more coherent tiles; initiate, by a first coherent tile within a first region within the plurality of regions, a snoop operation; generate, by the first coherent tile, a snoop vector for each region in the plurality of regions, wherein the snoop vector for each region selects at least one other coherent tile within the M×N mesh topology; send, by the first coherent tile, for each region in the plurality of regions, the snoop operation, wherein the sending is based on the snoop vector for each region; and process, by the at least one other coherent tile, the snoop operation.

As can now be appreciated, disclosed embodiments improve processor performance by enabling efficient cache operation with a mesh topology. Disclosed embodiments reduce the amount of traffic generated to maintain cache coherence. This involves dividing a mesh topology into multiple regions, and using a targeted multi-cast snoop vector and/or a coarse multi-cast snoop vector to control the way data is shared and updated among the caches to reduce unnecessary data movement, thereby improving processor performance and utilizing compute resources in a more efficient manner.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for processor data sharing comprising:
accessing a system-on-a-chip (SOC), wherein the SOC includes a network-on-a-chip (NOC), wherein the NOC includes an M×N mesh topology, wherein the M×N mesh topology includes a coherent tile at each point of the M×N mesh topology;
dividing the M×N mesh topology into a plurality of regions, wherein each region in the plurality of regions includes one or more coherent tiles;
initiating, by a first coherent tile within a first region within the plurality of regions, a snoop operation;
generating, by the first coherent tile, a snoop vector for each region in the plurality of regions, wherein the snoop vector for each region selects at least one other coherent tile within the M×N mesh topology;
sending, by the first coherent tile, for each region in the plurality of regions, the snoop operation, wherein the sending is based on the snoop vector for each region; and
processing, by the at least one other coherent tile, the snoop operation.

2. The method of claim 1 wherein the snoop vector for each region includes a region ID.

3. The method of claim 2 wherein the region ID comprises one or more bits corresponding to each region in the plurality of regions.

4. The method of claim 2 wherein the sending includes every coherent tile within each region in the plurality of regions.

5. The method of claim 4 wherein the sending is accomplished in a single clock cycle.

6. The method of claim 1 wherein the snoop vector for each region in the plurality of regions includes a region ID and a coherent tile ID.

7. The method of claim 6 further comprising identifying, with the region ID and the coherent tile ID, the at least one other coherent tile within the M×N mesh topology.

8. The method of claim 7 wherein the identifying is based on a directory-based snoop filter (DSF) within the first coherent tile.

9. The method of claim 8 wherein the sending is accomplished with a unique clock cycle for each region in the plurality of regions.

10. The method of claim 8 wherein the DSF determines a current owner of a cache line.

11. The method of claim 8 wherein the DSF determines one or more sharers of a cache line.

12. The method of claim 8 wherein the DSF stores information pertaining to a specific address range.

13. The method of claim 1 wherein the sending is based on a region priority.

14. The method of claim 1 wherein the coherent tile at each point of the M×N mesh topology comprises a switching unit (SU).

15. The method of claim 1 wherein the first coherent tile includes a cache coherency block (CCB) and a coherency ordering agent (COA).

16. The method of claim 1 wherein the one or more other coherent tiles includes one or more I/O control interfaces (ICIs).

17. The method of claim 1 wherein the NOC includes a point-to-point packetized communication protocol.

18. The method of claim 1 wherein the snoop operation is an invalidating snoop operation.

19. A computer program product embodied in a non-transitory computer readable medium for processor data sharing, the computer program product comprising code which causes one or more processors to generate semiconductor logic for:
accessing a system-on-a-chip (SOC), wherein the SOC includes a network-on-a-chip (NOC), wherein the NOC includes an M×N mesh topology, wherein the M×N mesh topology includes a coherent tile at each point of the M×N mesh topology;
dividing the M×N mesh topology into a plurality of regions, wherein each region in the plurality of regions includes one or more coherent tiles;
initiating, by a first coherent tile within a first region within the plurality of regions, a snoop operation;
generating, by the first coherent tile, a snoop vector for each region in the plurality of regions, wherein the snoop vector for each region selects at least one other coherent tile within the M×N mesh topology;
sending, by the first coherent tile, for each region in the plurality of regions, the snoop operation, wherein the sending is based on the snoop vector for each region; and
processing, by the at least one other coherent tile, the snoop operation.

20. A computer system for processor data sharing comprising:
a memory which stores instructions;
one or more processors coupled to the memory wherein the one or more processors, when executing the instructions which are stored, are configured to:
access a system-on-a-chip (SOC), wherein the SOC includes a network-on-a-chip (NOC), wherein the NOC includes an M×N mesh topology, wherein the M×N mesh topology includes a coherent tile at each point of the M×N mesh topology;
divide the M×N mesh topology into a plurality of regions, wherein each region in the plurality of regions includes one or more coherent tiles;
initiate, by a first coherent tile within a first region within the plurality of regions, a snoop operation;
generate, by the first coherent tile, a snoop vector for each region in the plurality of regions, wherein the snoop vector for each region selects at least one other coherent tile within the M×N mesh topology;
send, by the first coherent tile, for each region in the plurality of regions, the snoop operation, wherein the sending is based on the snoop vector for each region; and
process, by the at least one other coherent tile, the snoop operation.
